(19) United States
(12) Patent Application Publication
(10) Pub. No.: US 2014/0031095 A1
(43) Pub. Date: Jan. 30, 2014

(54) FOLD OUT CELLULAR PHONE CASE

(71) Applicants: Juan Herrera, Kearns, UT (US); Victor Hiphong, Riverton, UT (US)

(72) Inventors: Juan Herrera, Kearns, UT (US); Victor Hiphong, Riverton, UT (US)

(21) Appl. No.: 13/784,793

(22) Filed: Mar. 4, 2013

Related U.S. Application Data
(60) Provisional application No. 61/606,341, filed on Mar. 2, 2012.

(51) Int. Cl. H04M 1/02

(52) U.S. Cl. CPC H04M 1/0206
USPC 455/575.3

(57) ABSTRACT

A cellular phone case comprising at least two parts rotateably affixed to each other such that a first part, sized and shaped to hold a cellular phone can be rotated with respect to the second part such that the second part may act as a handle.

### CROSS-REFERENCE TO RELATED APPLICATIONS

This application claims the benefit of U.S. Provisional Application No. 61/606,341 filed Mar. 2, 2012 in the United States Patent and Trademark Office which is hereby incorporated by reference herein in its entirety, including but not limited to those portions that specifically appear hereinafter, the incorporation by reference being made with the following exception: In the event that any portion of the above-referenced applications are inconsistent with this application, this application supersedes said above-referenced application.

### STATEMENT REGARDING FEDERALLY SPONSORED RESEARCH OR DEVELOPMENT

Not Applicable.

### BACKGROUND

1. The Field of the Invention

This disclosure relates generally to a foldable cellular phone case. Specifically, it relates to a multiple piece cellular phone case wherein the multiple pieces move with respect to each other and may include additional functionality to enhance the functionality of the cellular phone.

2. Description of Related Art

Thus, it is an object of this invention to provide a multiple piece cellular phone case.

It is a further object of this invention to provide a multiple piece cellular phone case wherein the pieces move with respect to each other.

It is a further object of this invention to provide a multiple piece cellular phone case wherein at least one piece can function as a handle for the cellular phone.

It is a further object of this invention to provide a multiple piece cellular phone case that provides improved functionality and utility to the cellular phone.

### SUMMARY

This disclosure relates generally to a foldable cellular phone case. Specifically, it relates to a multiple piece cellular phone case wherein the multiple pieces move with respect to each other and may include additional functionality to enhance the functionality of the cellular phone.

### BRIEF DESCRIPTION OF THE DRAWINGS

The features and advantages of the disclosure will become apparent from a consideration of the subsequent detailed description presented in connection with the accompanying drawings in which:

FIG. 1 is a perspective view of the case;

FIG. 1a is an exploded view of the case;

FIG. 2 is a cutaway view of a ball and socket connection;

FIG. 2a is a perspective view of the case with a ball and socket connection;

FIG. 2b is a cutaway view of a ball and socket connection;

FIG. 2c is a cutaway view of a ball and socket connection;

FIG. 3 is a cutaway view of a ball and socket connection;

FIG. 4 is a perspective view of a case with two planes of rotation;

FIG. 4a is a perspective view of a case with two planes of rotation;

FIG. 4b is a perspective view of a case with two planes of rotation in and open position;

FIG. 5 is a perspective view of a case with a keyboard;

FIG. 5a is a perspective view of a case with a keyboard in the stowed position;

FIG. 6 is a perspective view of the case with a tripod;

FIG. 6a is a perspective view of the case with a fitting for a tripod;

FIG. 6b is a perspective view of a tripod;

FIG. 7 is a perspective view of a case with a kickstand;

FIG. 8 is a perspective view of a case with a phone connector built in;

FIG. 9 is a perspective view of a phone case with remote controls.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principals of the disclosure as illustrated herein, which would normally occur to one skilled in the relevant are and having possession of this disclosure, are to be considered within the scope of the disclosure claimed.

Before the present cellular phone case is disclosed an described it is to be understood that this disclosure is not limited to the particular configurations, process steps, and materials disclosed herein as such configurations, process steps, and materials may vary somewhat. It is also to be understood that the terminology employed herein is used for the purposed of describing particular embodiments only and is not intended to be limiting since scope of the present disclosure will be limited only by the appended claims and equivalents thereof.

The publications and other reference materials referred to herein to describe the background of the disclosure, and to provide additional detail regarding its practice are hereby incorporated by reference herein in their entireties, with the following exception: In the event that any portion of said reference materials is inconsistent with this application, this application supersedes the said reference materials. The reference materials discussed herein are provided solely for their disclosure prior to the filing date of the present application. Nothing herein is to be construed as a suggestion or admission that the inventors are not entitled to antedate such disclosure by virtue of prior disclosure, or to distinguish the present disclosure form the subject matter disclosed in the reference materials.

It must be noted that, as used in this specification and the appended claims, the singular forms “a,” “an,” :and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, un-recited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

As used herein, the term “distal” shall generally refer to the opposite of proximal, and thus to the concept of a further portion, or a furthest portion, depending upon the context.

As used herein, the phrase “in an at least partially proximal-to-distal direction” shall refer generally to a two-dimensional concept of direction in which the “proximal-to-distal” direction defines one direction or dimension. An item that extends in a non-parallel direction with respect to the “proximal-to-distal” direction, that is, at a non-straight angle thereto, thereby involves two components of direction, one of which is in the “proximal-to-distal” direction an the other being in a direction orthogonal to the “proximal-to-distal” direction.

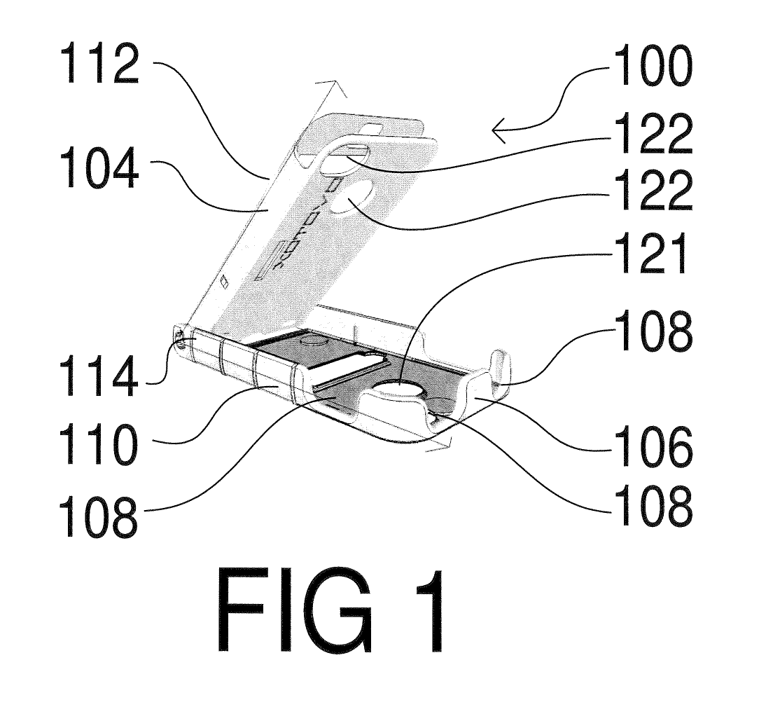

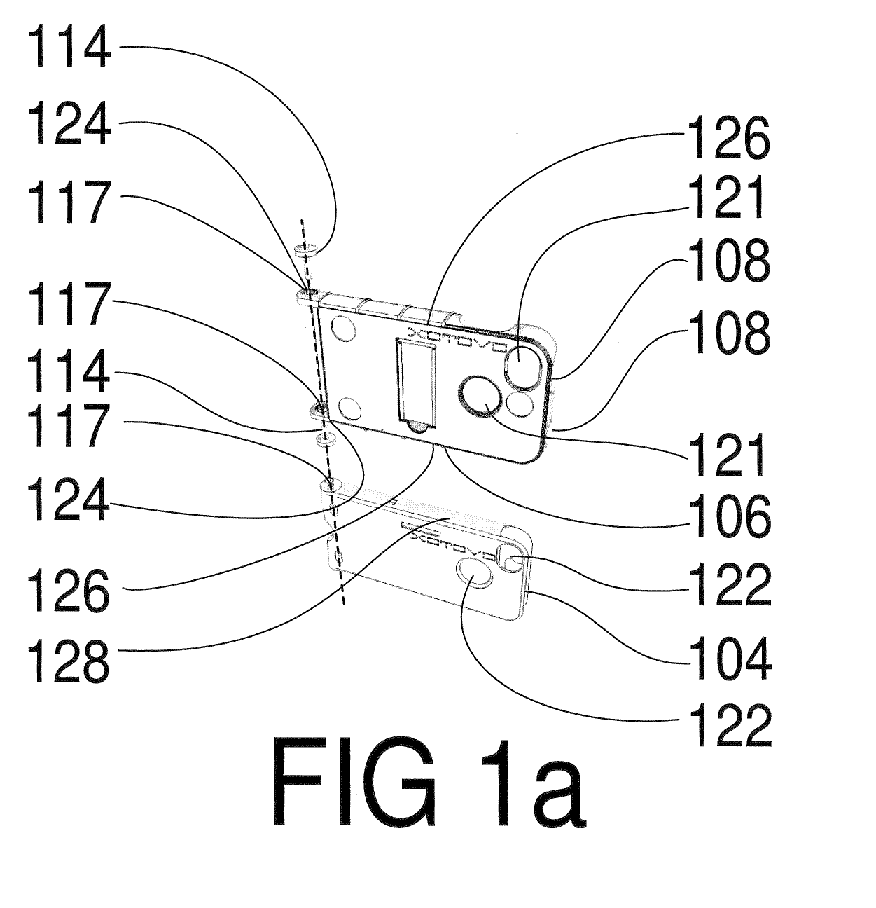

In accordance with the present embodiment, FIG. 1 depicts a cellular phone case 100 having a first part 104 comprising a compartment sized and shaped to irremovably receive a cellular telephone and a second part 106 comprising a casing sized and shaped to receive the said first part 104 so that the said first part 104 can nest inside the said second part 106. The second part 106 comprises apertures 108 sufficient to reveal the functional ports of the cellular phone such as the volume controls, the USB/power port and/or the headphone jack when the first part 104 is nested inside the second part 106.

The first part 104 is sized and shaped to irremovably accept the phone such that the cellular telephone can be inserted into the case in an upside down or a backward and forward orientation. The first part 104 comprises apertures 122 that expose the phone's camera lens when the phone is oriented in the case 100 such that the screen is exposed. The second part 106 also comprises apertures 121 that that expose the phone's camera lens when the first part 104 is nested inside the second part 106.

The said first part 104 is pivotally attached to the said second part 106 such that said first part 104 can pivot with respect to the said second part 106 from a resting position nested inside said second part 106, to a position wherein the long axis 110 of the first part 104 and the long axis 112 of the second part 106 define an angle between 1 and at least 270 degrees. This said pivotal attachment may be accomplished by means of inserting connectors 114 through corresponding openings the sides the said first part 104 and said second part 106 respectively. These connectors 114 may be pins, screws, rivets, bolts or any other means know to those of ordinary skill in the art.

As depicted in FIG. 1a, the openings 117 in said second part 106 are located on arms 124 located on the said second part's 106 lateral edges 126. The arms 124 are spaced such that they may be disposed outside the lateral edges 128 of the second part 104 such that the openings 117 in the arms 124 of the second part 106 align with the openings 117 in the first part 104. The corresponding openings may be located at either end of the corresponding first 104 and second parts 106 and are located so that they align when the first part 104 is nested into the second part. The connectors are then inserted through the aligned holes in the first part 104 and the second part 106.

The case 100 may be comprised of plastic or any similar polymer, steel, stainless steel or other steel alloy, aluminum, anodized aluminum, glass, carbon fiber, or any other material commonly known in the art. In another embodiment, the case 100 is sized and shaped to accommodate a computer tablet type device.

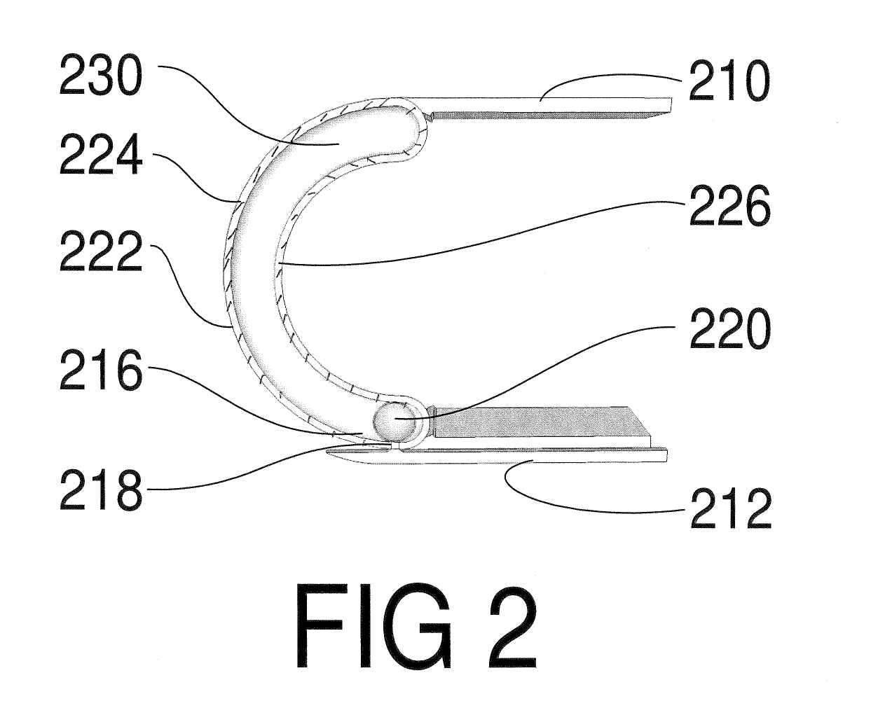

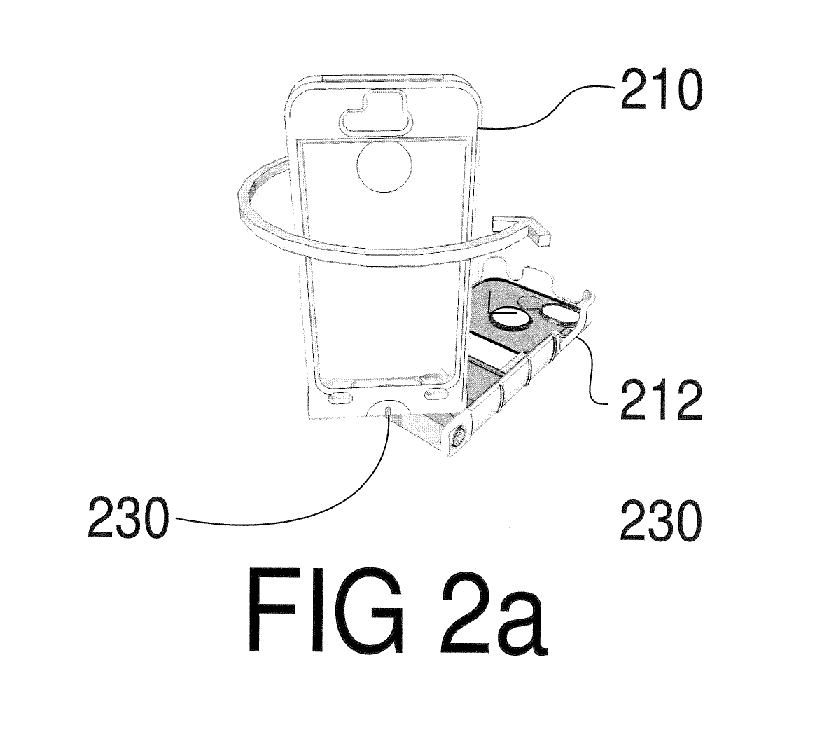

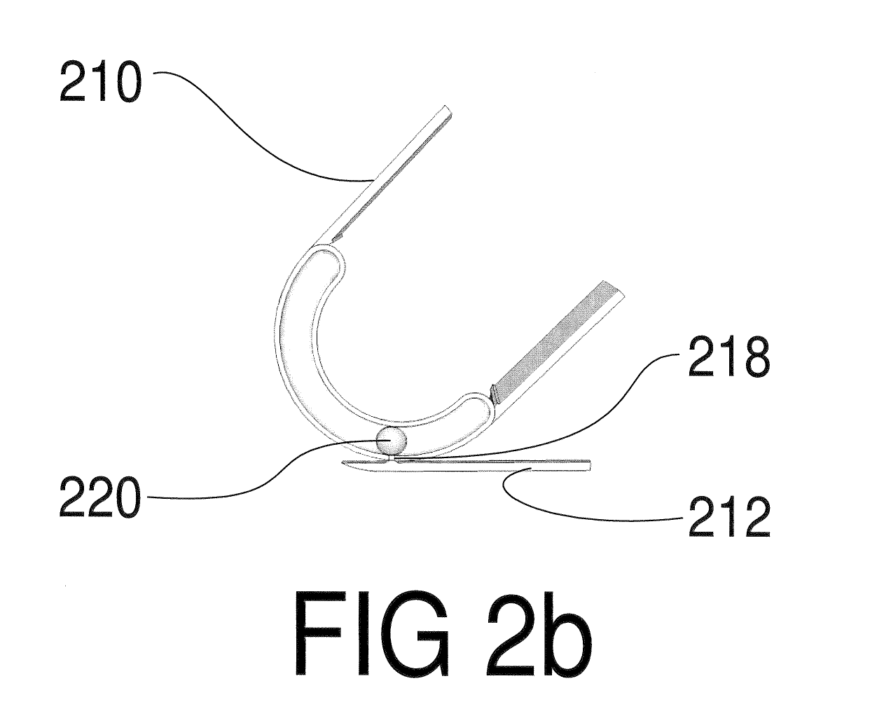

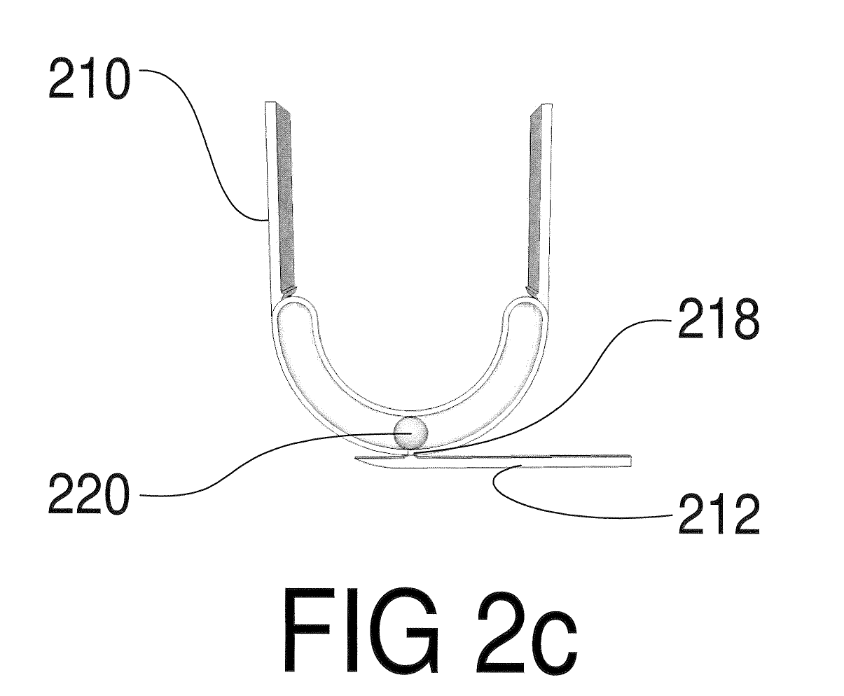

In yet another embodiment depicted in FIG. 2, the first part 210 is pivotally attached to the second part 212 by means of a ball and socket type hinge member 216. As depicted in FIG. 2, one half of the hinge member comprises a stem 218 with a head member 220 on it its distal end. The head member 220 is generally spherical in shape. The stem 218 is affixed to the second part 212. The stem 218 may be plastic, metal, nylon, cable or any other material suitably strong to maintain a connection with the first part 210 and the second part 212. The other half of hinge member 216 comprises a curved track 222. The curved track 222 comprises a first side 224 and a second side 226 whose interior surfaces define a curved interior space 230.

The interior space 230 is sized and shaped to engage the outside surface of the head member 220. The tolerances should be sufficiently close that the forces of static friction between the head member 220 and the interior surfaces of the curved track 222 are strong enough to maintain the orientation of the first part 210 with respect to the second part 212 but sufficiently weak enough that their orientation can be changed by manipulation by the user's hands.

As depicted in FIG. 2a, the first side 224 comprises an aperture 230 sized and shaped to allow the stem 218 to pass through it. FIG. 2a illustrates the manner in which the ball allows the second part to rotate around its long axis. The aperture 230 is also sized and shaped to prevent the head member 220 from passing through. FIGS. 2b and 2c depict the manner in which the first part 210 can rotate with respect to the second part 212 and the various orientations the two parts can assume with respect to each other while FIG. 2a illustrates the manner in which the first part 210 may also rotate laterally with respect to the first part 212. Finally, it should be understood that in an alternative embodiment, the first part may comprise the curved track while the second part may comprise the head member.

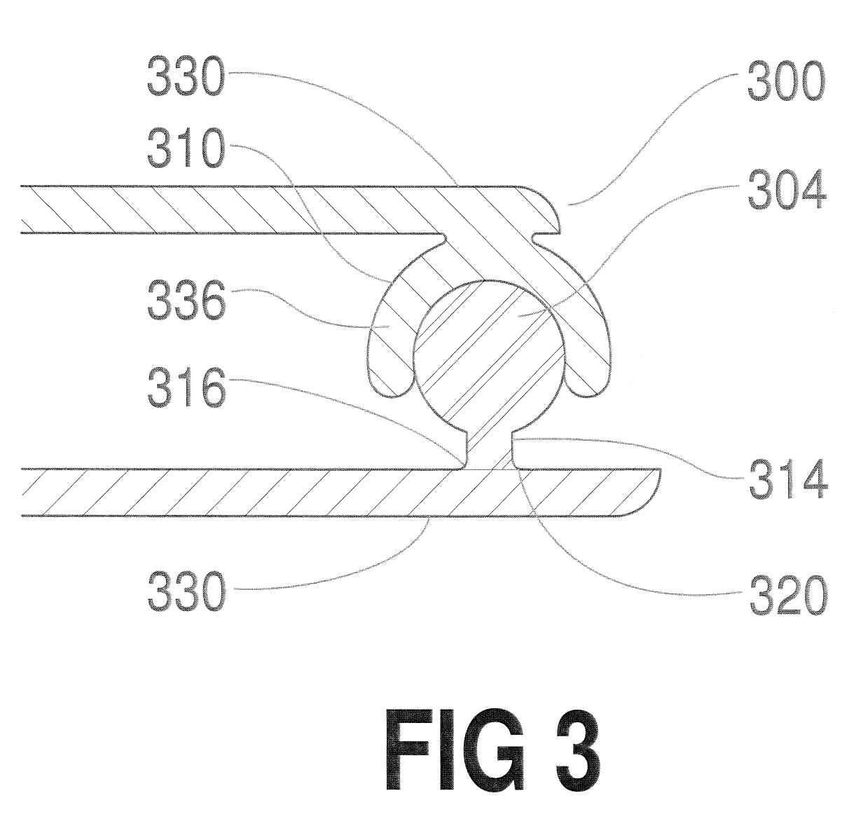

FIG. 3 depicts another embodiment in which the case 300 comprises a ball and socket mechanism 310. The ball and socket mechanism 310 comprises a stem member 314. The stem member 314 comprises a base 316 located on the stem member's 314 first 320 end and a ball 324 located on the stem member's 314 second end. The base 316 is affixed to the first part 330 of the case 300. A socket 336 is affixed to the second part 340 of the case 300 and is sized and shaped such that the ball 324 can fit securely into the socket 336 such that the inside surface of the socket 336 is in contact with the surface of the ball 324 with sufficient force to hold the ball 324 in a particular orientation via the forces of static friction, but not with sufficient force to prevent the ball 324 from being moved with respect to the socket 336 through manipulation by the user's hands. The socket 336 comprises an opening through which the stem member 314 extends. The opening of the socket 336 is sized such that the inside surface of the socket 336 describes a sphere that is several degrees greater than 180 in circumference so that when the ball 324 in inserted in the socket 336, the ball 324 is held securely in the socket 336 by the fact that the resulting opening in the socket 336 is smaller than the diameter of the ball 324.

In another embodiment, either the socket 336, the ball 324 or both may be magnetized in a manner that the magnetic forces help hold the ball in place with respect to the socket 336.

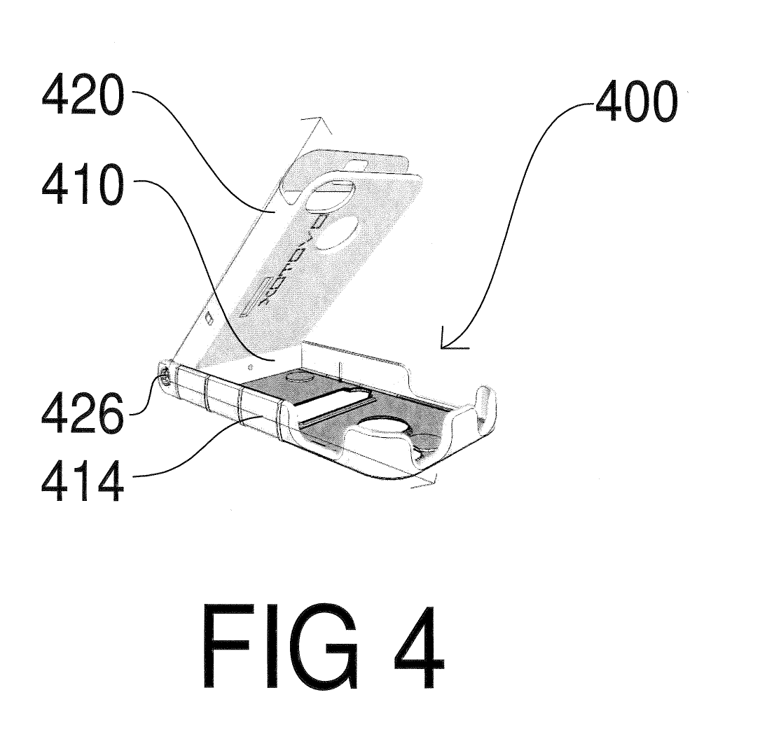

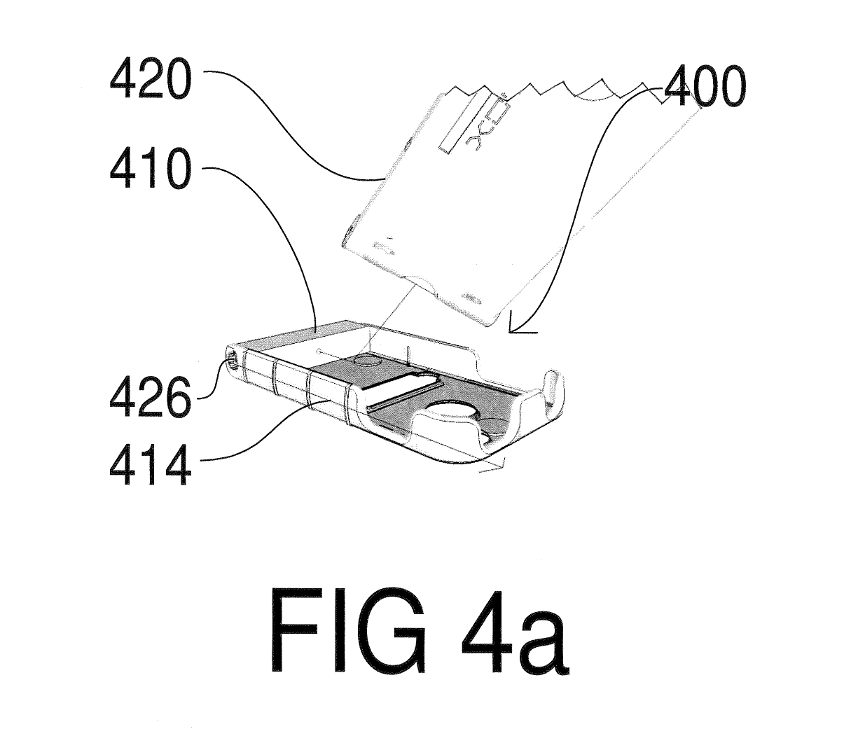

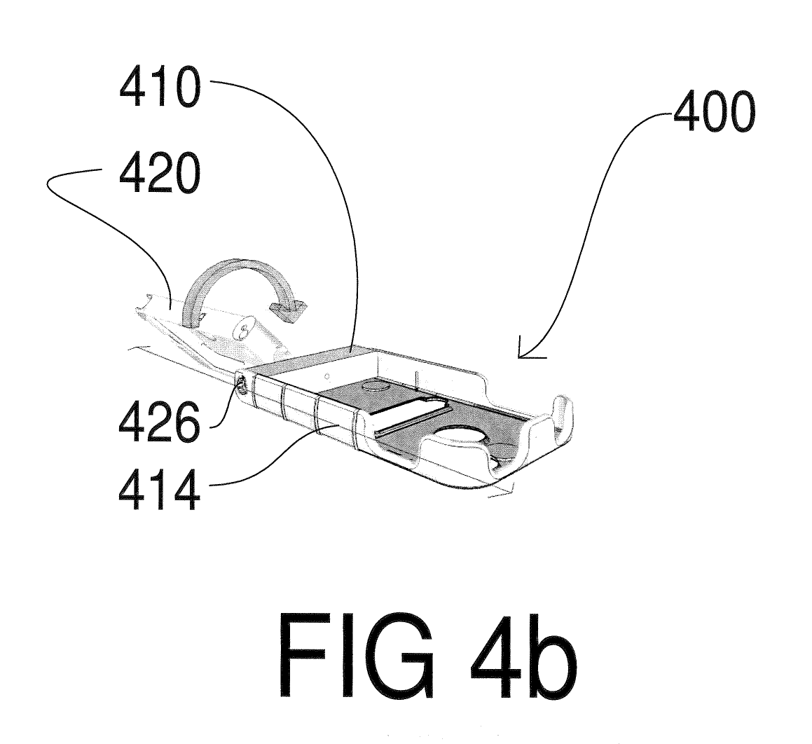

In another embodiment depicted in FIG. 4, the first part 420 can rotate in at least two planes with respect to the first part 414. This rotation is two planes is accomplished by a pivot member 410 rotatably attached to the second part 414. The pivot member 410 may be attached to the second part 414 by a pin 426, bolt, rivet, or any other means known to those of ordinary skill in the art. As depicted in FIG. 4a, the first part 420 is rotatably affixed to the pivot member 410. This may be accomplished by a screw 426, a pin, rivet, bolt or any other means known to those of ordinary skill in the art. As depicted in FIG. 4a, the pivot member 410 is oriented such that when first part 420 is affixed to it, the first part 420 is in a nesting position inside the second part 414. FIG. 4b depicts the case 400 wherein the pivot member 410 is rotated to a position 180 degrees from its position depicted in FIG. 4a. The first part 420 has rotated around the screw 426.

In the alternative, the ability to pivot in two planes may be accomplished by rotatably affixing a pivot member to a bottom edge of the second part 414. Arms rotatably attached to either end of the pivot member and securely affixed to the first part 420 would allow for the rotation of the first part 420 in the same plane as the second part 414.

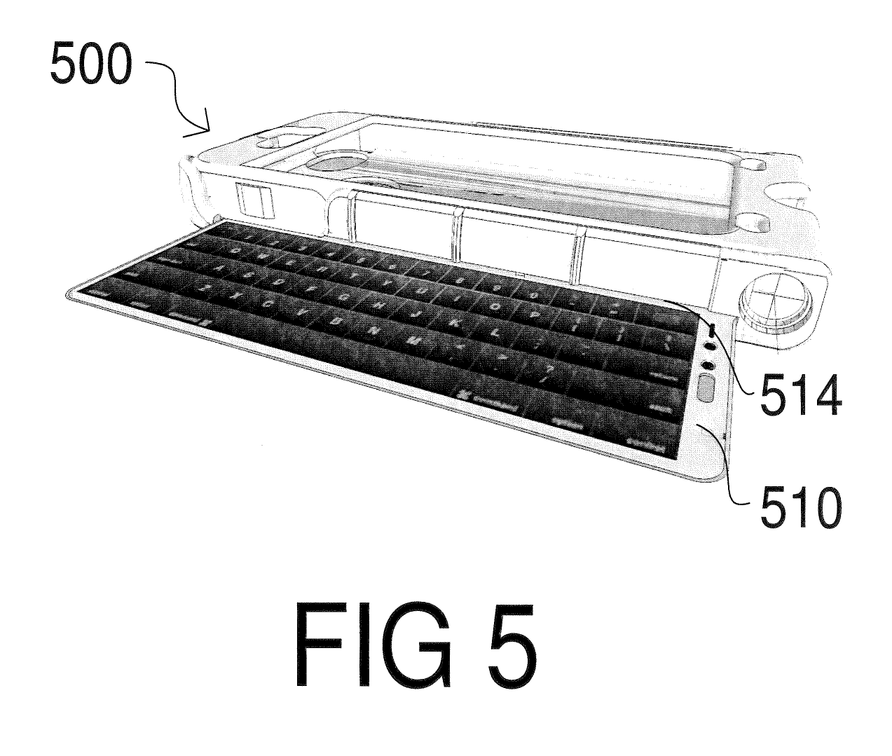

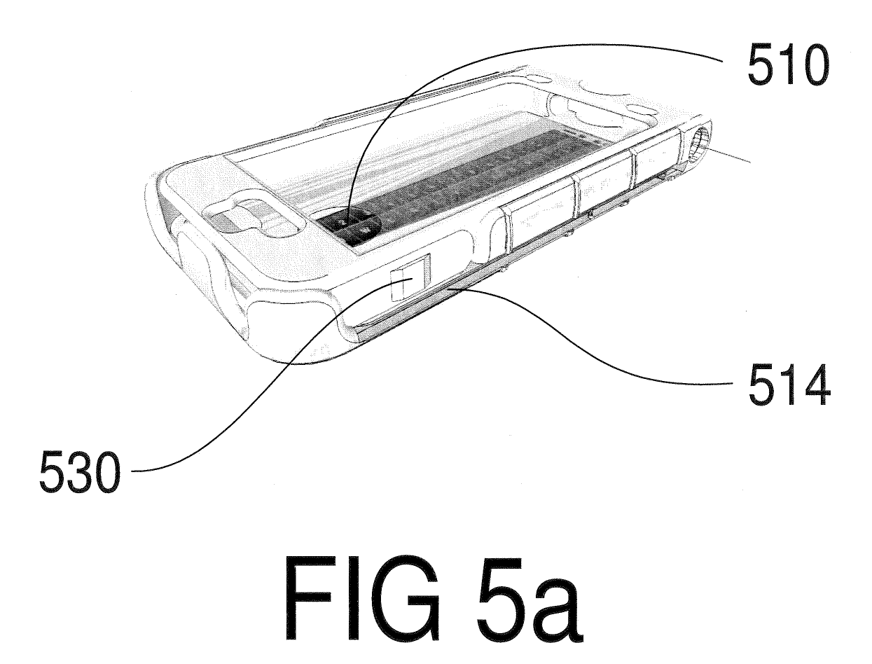

In yet another embodiment, depicted in FIG. 5, the a cellular telephone case 500 comprises a keyboard 510. As depicted in FIG. 5, the keyboard 510 fits into a recess 514 located in the case 500. The keyboard 510 is slideably attached to the case 500 such that the keyboard travels on a track (not shown) from its form its storage position in the recess 514 to its deployed position as depicted in FIG. 5. The keyboard 514 may be spring-loaded into the case and released via a button as depicted in FIG. 5a located on the case 500. The keyboard 514 may communicate with the cellular telephone via blue tooth technology or any other electromagnetic communication protocol. In the alternative, the keyboard 514 may also communicate with the phone via hard Wiring between the keyboard and the cellular telephone.

FIG. 5a depicts the case 500 with the keyboard 510 in the stowed position within the case 500. The keyboard may be spring loaded such that it is releasable by a button 530 located on the case.

In another embodiment, the keyboard 510 may be rotatably attached to the case 510 such that it can pivot from its storage position in the recess 514 to its usable position extending laterally from the broad surface of the case. In yet another embodiment, the keyboard 510 snaps into the recess 514 and can be completely detached form and used separately from the case.

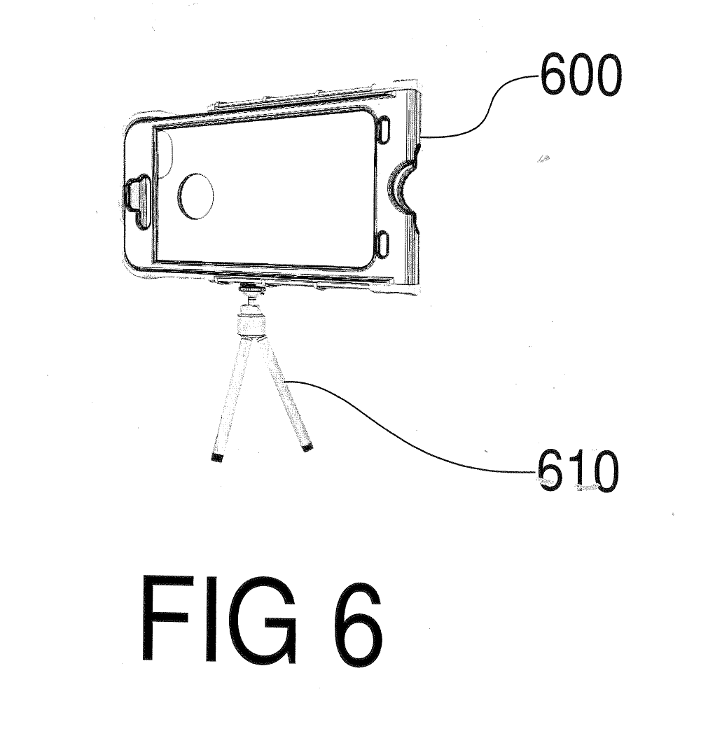

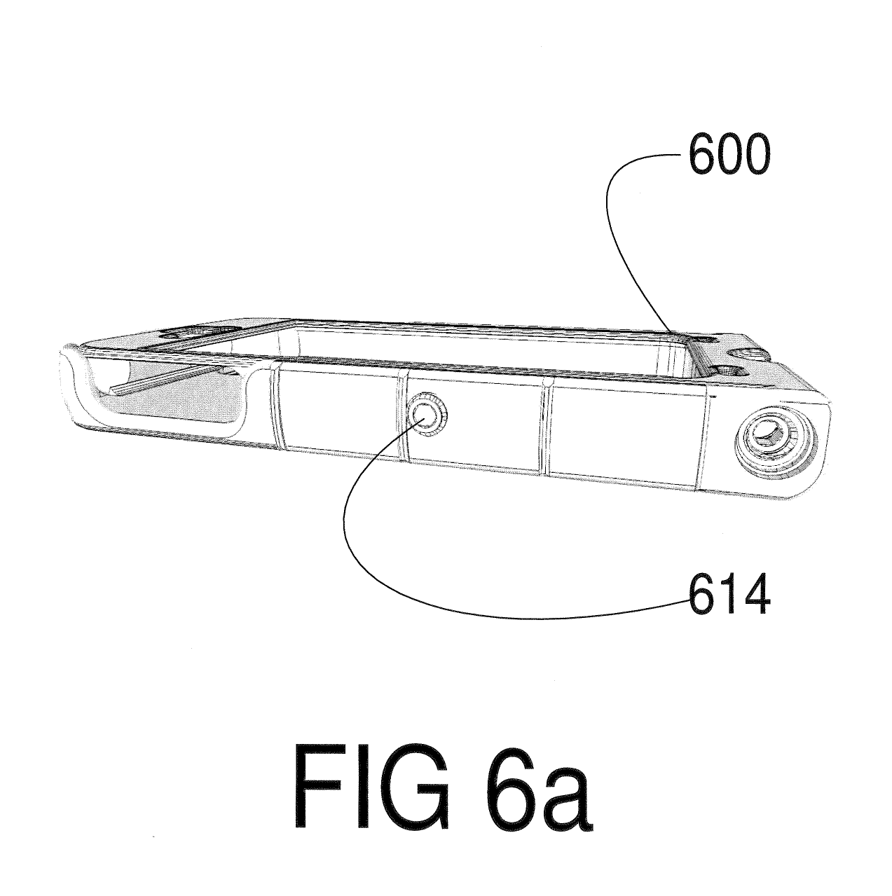

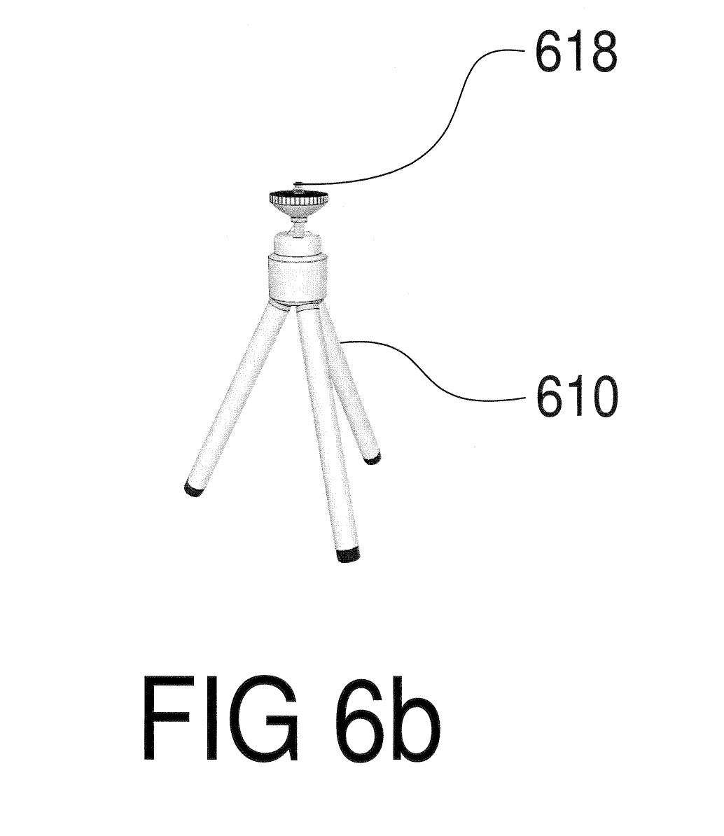

In another embodiment, depicted in FIG. 6, the cellular phone case 600 comprises a tripod stand 610. This tripod stand 610 is detachable from the case 600. As depicted in FIG. 6a the tripod stand 610 attaches to the case 600 via a threaded receiver 614 in the case 600. A threaded end 618 of the tripod stand 610 depicted in FIG. 6b screws into the threaded receiver 614.

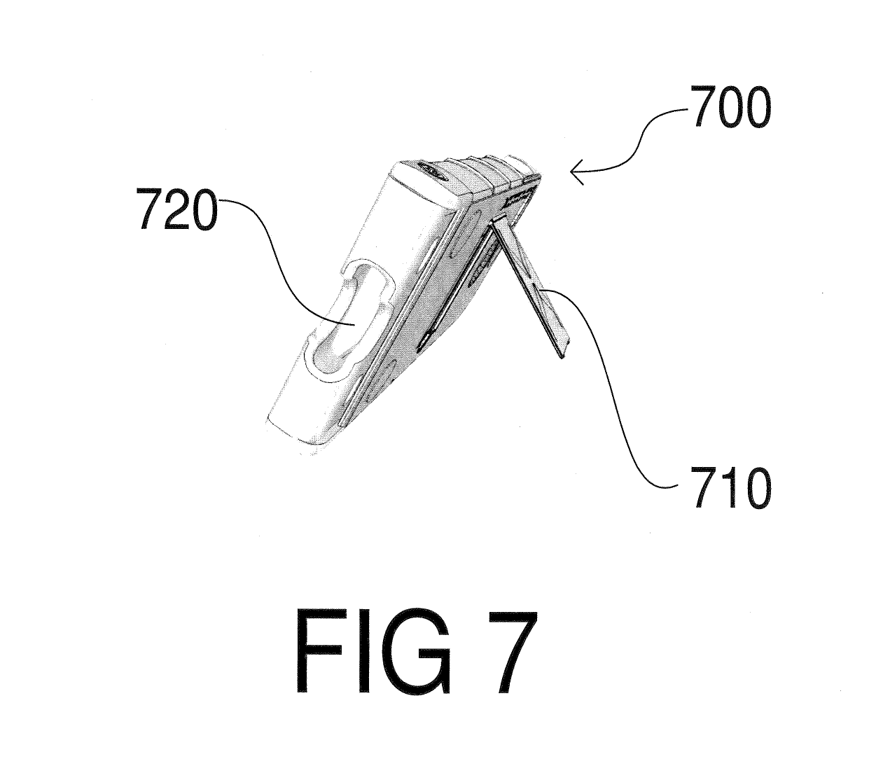

In yet another embodiment, depicted in FIG. 7, the cellular phone case 700 comprises a kickstand 710 that can be used to support the phone case 700 at an angle. The phone case of FIG. 7 further comprises an opening 710 to accept a connector to the phone such as a 30 pin connector.

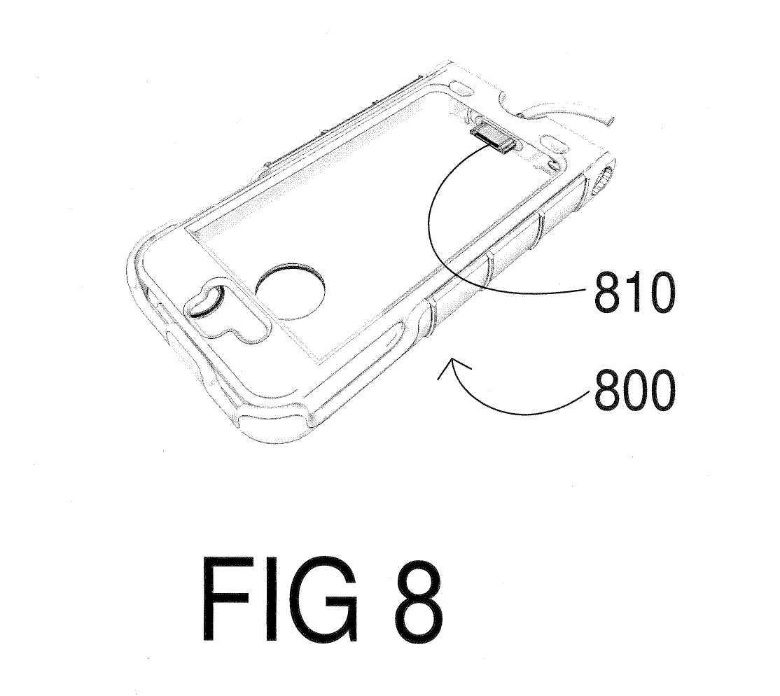

FIG. 8 depicts a case 800 comprising a cellular telephone connector 810, such as a 30 pin connector, affixed to the case 800 such that the connector 810 inserts into the corresponding port of the cellular telephone when the cellular phone is inserted into the case.

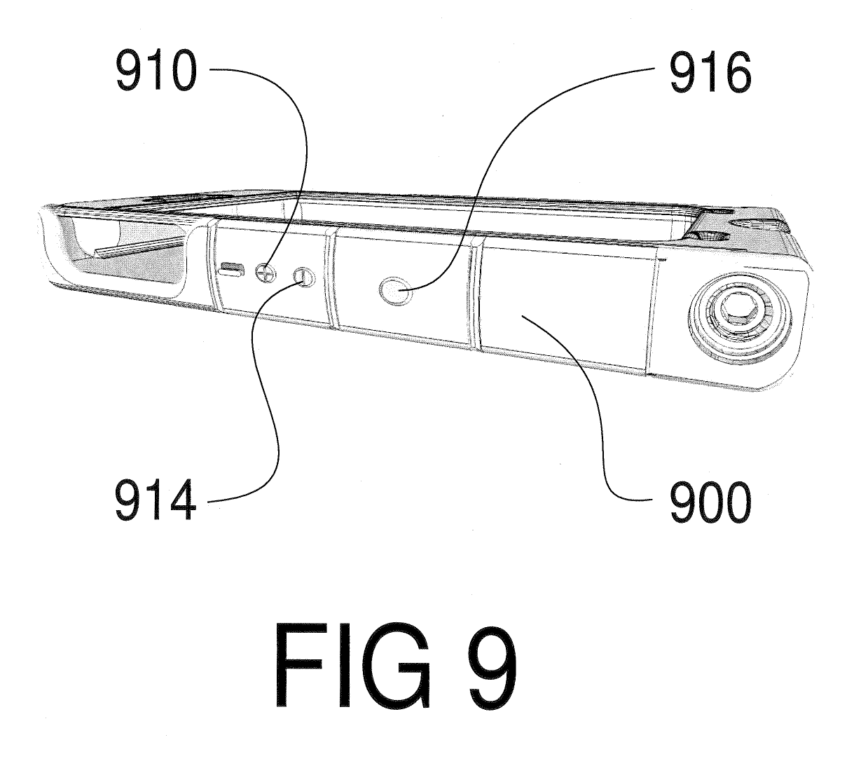

FIG. 9 depicts another embodiment in which the cellular phone case 900 comprises fixtures that operate the various functions of the cellular phone. In the embodiment, the case 900 may comprise at least one control 910 that operates the shutter of the cellular phone camera. The case may also possess a control 914 that operates the zoom in/zoom out feature of the cellular phone camera. Finally the case 900 may also possess a control 916 that operates the video cameral function of the cellular phone. These controls may communicate with the cellular phone via hardwiring or via blue tooth or any other type of electromagnetic communication protocol known to those of ordinary skill in the art.

The cellular phone case also is sized and shaped to receive a battery. The battery in turn communicates electrically with the charging port on the cell phone. The cellular phone case also comprises a flash device. The flash device is powered by a battery along with a capacitor.

What is claimed is:

1. A cellular phone case comprising:
a first part comprising a compartment sized and shaped to removably receive a cellular phone said second comprising a casing sized and shaped to receive the said first part so that the said first part can nest inside the said second part
said first part being pivotally attached to the said second part such that said first part can pivot with respect to the said second part from a resting position nested inside said second part, to a position wherein the angle between a line describing a long axis of the first part and a line describing the long axis of the second part define an angle between 1 and at least 270 degrees.

2. The cellular phone case of claim 1 wherein the said first part is pivotally attached to the said second part by means of a pin member that passes through a hole in the sidewall of the said first part and through a hole in the sidewall of the said second part such that the said first part can rotate around the pin member and move relative to the said second part.

3. The cellular phone case of claim 1 wherein the said first part is pivotally attached to the said second part by means of a hinge member attached to the said first member and the said second member, said hinge member pivotally connecting the said first part to the said second part.

4. The cellular phone case of claim 1 wherein the said first part possesses apertures sufficient to reveal the functional ports of the cellular phone.

5. The cellular phone case of claim 1 wherein the said second part comprises a threaded receiver that can removeably attach to a tripod.

6. The cellular phone case of claim 1 wherein the case contains at least one controls that operate functions of the cellular phone.

7. The cellular phone case of claim 6 wherein at least one control communicates wirelessly with the cellular phone.

8. The cellular phone case of claim 7 wherein at least one control communicates with the cellular phone via electromagnetic waves.

9. The cellular phone case of claim 8 wherein the at least one control communicates with the cellular phone via blue tooth technology.

10. The cellular phone case of claim 1 wherein the case comprises at least one control that operates the shutter of the cellular phone's camera function.

11. The cellular phone case of claim 1 wherein the case comprises at least one control that operates the cellular phone's video camera function.

12. The cellular phone case of claim 1 wherein the case comprises at least one control that operates the zoom in/zoom out feature of the cellular phone's camera function.

13. The cellular phone case of claim 1 wherein the case comprises a flash device.

14. The cellular phone case of claim 1 further comprising a keyboard.

15. The cellular phone case of claim 12 wherein the keyboard is slideably movable into its position to be used.

16. A cellular phone case having:
a first part comprising a compartment sized and shaped to removably receive a cellular phone said second comprising a casing sized and shaped to receive the said first part so that the said first part can nest inside the said second part
said first part being pivotally attached to the said second part such that said first part can pivot with respect to the said second part along at least two planes of rotation.

17. The cellular phone case of claim 16 wherein the first part is pivotally attached to the second part by means of a ball and socket mechanism.

18. The cellular phone case of claim 17 wherein the socket comprises a curved track.

19. The cellular phone case of claim 16 wherein the first part is pivotally attached to the second part by means of a pivot member attached to both the first part and the second part.

20. A cellular phone case comprising:
a first part comprising a compartment sized and shaped to removably receive a cellular phone said second comprising a casing sized and shaped to receive the said first part so that the said first part can nest inside the said second part
said first part being pivotally attached to the said second part such that said first part can pivot with respect to the said second part along at least two planes of rotation;
wherein the first part is pivotally attached to the second part by means of a pivot member attached to both the first part and the second part:
wherein the second part comprises apertures sufficient to reveal the functional ports of the cellular phone; and,
wherein the first part and the second part comprise apertures that are sized and shaped to expose the cellular phone's camera lense.
